(19) United States
(12) Patent Application Publication
(10) Pub. No.: US 2023/0399177 A1
(43) Pub. Date: Dec. 14, 2023

(54) METHOD AND SYSTEM FOR PROCESSING ITEM ORDER

(71) Applicant: Floatic Inc., Seoul (KR)

(72) Inventors: Seung Hoon Lee, Seoul (KR); Jae Hoon Jung, Seoul (KR); Young Hoon Lee, Seoul (KR)

(73) Assignee: Floatic Inc., Seoul (KR)

(21) Appl. No.: 18/206,960

(22) Filed: Jun. 7, 2023

(30) Foreign Application Priority Data
Jun. 9, 2022 (KR) 10-2022-0069973

(51) Int. Cl. B65G 1/137; G06Q 10/0631; G06Q 50/28

(52) U.S. Cl. CPC B65G 1/1378; G06Q 10/06316; G06Q 50/28

(57) ABSTRACT

A method for processing an item order is provided, which is performed by one or more processors and includes acquiring order information including a plurality of item orders, generating a plurality of works based on the order information, setting a work group including some or all of the plurality of generated works, and setting a group field including a work attribute in the work group.

### CROSS-REFERENCE TO RELATED APPLICATION

This application claims priority under 35 U.S.C § 119 to Korean Patent Application No. 10-2022-0069973, filed in the Korean Intellectual Property Office on Jun. 9, 2022, the entire contents of which are hereby incorporated by reference.

### TECHNICAL FIELD

The present disclosure relates to a method and system for processing an item order, and more particularly, to a method and system for processing an item order by setting a work group and controlling so that a work for the item order is processed based on the set work group.

### BACKGROUND

With the advent of the 4th industrial revolution era, manufacturing and logistics industries are on a trend to spread automation while lowering labor costs and increasing efficiency. Reflecting this trend, unmanned transfer robots are rapidly spreading in the manufacturing and logistics industries. The unmanned transfer robot refers to an industrial robot or vehicle that moves automatically without the intervention of a driver or operator. The unmanned transfer robot has a built-in system designed to perform independent movements by algorithms and move along a defined path with built-in power.

The unmanned transfer robot is assigned works through a server, and moves to shelves where items are stored based on the assigned works. In addition, the unmanned transfer robot may receive items from the worker, store the items in the storage box, and move to a designated destination.

The method for working using the unmanned transfer robot includes, upon receiving a new item order at a server, generating a work corresponding to one item included in the received order, and transmitting the generated work to the unmanned transfer robot. Based on the work, the unmanned transfer robot moves to the shelf storing the item. Meanwhile, this method uses 1:1 mapping between the unmanned transfer robot and the work, so the work speed is slow and the work efficiency is low.

Accordingly, the logistics automation technology is being developed, which groups a plurality of works and controls the unmanned transfer robots to collectively process the grouped plurality of works. However, most of the logistics automation technologies currently being developed are those that are optimized for specific distribution systems as a result of obtaining and analyzing all internal data of the specific distribution systems, and therefore, there are many limitations in applying these to the other distribution systems. That is, the related logistics automation technology using unmanned transfer robot is applicable only to a specific customer's distribution system, and it is difficult to apply it as is to the other customer's distribution systems. Therefore, it requires many design changes to the logistics automation technology in order to apply the logistics automation technology to the distribution systems of the other customers.

### SUMMARY

In order to solve one or more problems (e.g., the problems described above and/or other problems not explicitly described herein), the present disclosure provides a method, a computer program stored in a recording medium, and an apparatus (system) for processing an item order.

The present disclosure may be implemented in various ways, including a method, an apparatus (system), or a computer program stored in a computer-readable storage medium, and a computer-readable storage medium in which the computer program is stored.

A method performed by one or more processors may comprise: acquiring order information including a plurality of item orders; generating, based on the order information, a plurality of works; setting a work group including at least one of the generated plurality of works; setting, for the work group, a group field including a work attribute; and transmitting, to a target robot and based on an amount of work assigned to a work station being less than a threshold value, a message including an attribute of the work station to cause the target robot to determine an action associated with the work station.

The method may further comprise: after the setting the group field, determining the target robot from among a plurality of robots; and transmitting, to the target robot, work data related to the work group.

The determining the target robot may comprise determining the target robot based on at least one of: a work quota of each of the plurality of robots; or a location of each of the plurality of robots.

The transmitting the message may comprise: after the transmitting the work data to the target robot, transmitting the message, and wherein the method further comprises causing the target robot to transfer, in response to the message, an item to the work station, and wherein an attribute of the item is related to the attribute of the work station.

The setting the work group may comprise: identifying an attribute of each item included in the order information; and setting, based on the identified attribute, at least one of the plurality of works in the work group, wherein the setting the group field comprises: based on a determination that an attribute of an item associated with the work group is related to the work attribute, setting the group field for the work group.

The setting the work group may comprise setting, in the work group, at least one of the plurality of works related to a same buyer.

The setting the work group may comprise: based on a delivery destination of each item, setting, in the work group, at least one work related to the delivery destination within a predetermined distance.

The method may further comprise: based on an order shift of an item, setting at least one work group related to a same order shift as a group for the order shift.

The setting the work group may comprise: identifying a location at which a work is to be performed; and based on the identified location, setting the work group including at least one of the plurality of works.

The identifying the location at which the work is performed may comprise: identifying a storage location of an item related to the work; and identifying the identified storage location as the location at which the work is to be performed.

The setting the work group may comprise: determining a processing sequence for each of the plurality of works; and setting, based on the determined processing sequence of each of the plurality of works, the work group.

The generating the plurality of works may comprise: identifying a storage location of each item included in the order information; and generating a work for each identified storage location.

An information processing system may comprise: one or more processors; and a memory storing instructions that, when executed by the one or more processors, cause the information processing system to: acquire order information including a plurality of item orders, generate, based on the order information, a plurality of works; set a work group including at least one of the generated plurality of works; set, for the work group, a group field including a work attribute; and transmit, to a target robot and based on an amount of work assigned to a work station being less than a threshold value, a message including an attribute of the work station to cause the target robot to determine an action associated with the work station.

A method performed by one or more processors may comprise: acquiring order information including a plurality of item orders, wherein each of the plurality of item orders includes associated item attributes; generating, based on the plurality of item orders, a plurality of works; grouping, based on item attributes, the generated plurality of works into a plurality of work groups, wherein each work group of the plurality of work groups includes works having a same item attribute or compatible item attributes; assigning a work attribute to each of the plurality of work groups; allocating the plurality of works to a plurality of robots; measuring an amount of work to be processed at a specific work station of a plurality of work stations; based on the measured amount of work being less than a threshold value, transmitting a message including an attribute of the specific work station to the plurality of robots, wherein the attribute of the specific work station indicates information related to characteristics of a subsequent work to be performed at the specific work station, and the attribute of the specific work station has at least one associated work attribute; and causing a specific robot of the plurality of robots to move, in response to the message, to the specific work station, wherein the specific robot that moves to the specific work station is a robot assigned a work having a work attribute associated with the attribute of the specific work station.

A method for processing an item order is provided, which may be performed by one or more processors and include acquiring order information including a plurality of item orders, generating a plurality of works based on the order information, setting a work group including some or all of the plurality of generated works, and setting a group field including a work attribute in the work group.

The method may include, after the setting the group field, determining a target robot from among a plurality of robots, and transmitting work data related to the work group to the target robot.

The determining the target robot may include determining the target robot based on at least one of a work quota of each of the plurality of robots or a location of each robot.

The method may further include, after the transmitting work data target robot, in response to an amount of work assigned to may further include work station being less than a threshold value, sending a message including an attribute of the work station, in which the robot responding to the message may transfers a picked item to the work station, and an attribute of the picked item may be related to the attribute of the work station.

The setting the work group may include identifying an attribute of each item included in the order information, and setting some or all of the plurality of works in the work group based on the identified item attribute, and the setting the group field may include, in response to determining that the attribute of the item included in the work group is related to the attribute of the work, setting the group field in the work group.

The setting the work group may include setting at least one work of the plurality of works related to the same buyer in the work group.

The setting the work group may include based on a delivery destination of each item, setting at least one work related to a delivery destination within a predetermined distance in the work group.

The method may include, based on an order shift of an item, setting at least one work group related to the same order shift as a group for the order shift.

The setting the work group may include identifying a location at which each work is performed, and setting the work group including some or all of the plurality of works based on the identified location of each work.

The identifying the location at which the work is performed may include identifying storage location for an item related to the work, and identifying the identified storage location as the location at which the work is performed.

The setting the work group may include determining a processing sequence for each of a plurality of works, and setting the work group based on the determined processing sequence of each work.

The generating the plurality of works may include identifying a storage location of each item included in the order information, and generating a work for each the identified storage location.

A method for processing an item order is provided, which may be performed by one or more processors and include acquiring order information including a plurality of item orders, in which each item order may include associated item attributes, generating a plurality of works based on the plurality of item orders, grouping the generated plurality of works into a plurality of work groups based on item attributes, in which each work group includes works having the same or compatible item attributes, assigning a work attribute to each of the plurality of work groups, allocating the plurality of works to a plurality of robots, and measuring an amount of work to be processed at a specific work station of a plurality of work stations and, in response to determining that the measured amount of work is less than a threshold value, transmitting a message including an attribute of the specific work station to the plurality of robots. The attribute of the specific work station may be information related to characteristics of a subsequent work to be performed at the specific work station, and the attribute of the specific work station may have at least one associated work attribute. In addition, in response to the message, a specific robot among a plurality of robots may move to a specific work station, and the specific robot that moved to the specific work station may be a robot assigned a work having a work attribute associated to the attribute of the specific work station.

In addition, there may be provided a computer-readable non-transitory recording medium storing instructions for causing performance of the item order processing method described above on a computer.

An information processing system is provided, which may include a memory, and one or more processors connected to the memory and configured to execute one or more computer-readable programs included in the memory, in which the one or more programs may further include instructions for acquiring order information including a plurality of item orders, generating a plurality of works based on the order information, setting a work group including some or all of the plurality of generated works, and setting a group field including a work attribute in the work group.

According to some examples of the present disclosure, works, work groups, and group fields can be defined in such a form that may be applicable to the distribution systems in different environments, and work data based on the works, work groups, and group fields may be generated and transmitted to unmanned transfer robots. Accordingly, at least one of the method, computer program, or system according to examples according to the present disclosure may be applied to various distribution systems without modifying an internal program or process.

According to some examples of the present disclosure, at least one work group may be assigned to a work station based on the attributes of the work station. For example, at least one work group may be assigned to any one of work stations based on the packaging method, delivery destination, ordering party, inspection method, etc. Accordingly, the method, computer program or system according to the examples according to the present disclosure may be universally applied to the distribution systems having various working environments.

According to some examples of the present disclosure, the unmanned transfer robots may be allocated to the work station where no load is generated, so that the load of the work station can be distributed.

The effects of the present disclosure are not limited to the effects described above, and other effects not described herein can be clearly understood by those of ordinary skill in the art (referred to as “ordinary technician”) from the description of the claims.

### BRIEF DESCRIPTION OF THE DRAWINGS

The above and other objects, features and advantages of the present disclosure will be described with reference to the accompanying drawings described below, where similar reference numerals indicate similar elements, but not limited thereto, in which:

FIG. 1 is a diagram illustrating an example of a distribution system applying a method and system for processing an item order;

FIG. 2 is a schematic diagram illustrating a configuration in which an information processing system is communicatively connected to a plurality robots and an item order placement server;

FIG. 3 is a block diagram illustrating an internal configuration of an information processing system;

FIG. 4 is a block diagram illustrating an internal configuration of a processor included in the information processing system;

FIG. 5 is a diagram illustrating a work group assigned a group field;

FIG. 6 is a diagram illustrating order information including different buyers;

FIG. 7 is a diagram illustrating work data in which work groups are set based on buyers;

FIG. 8 is a diagram illustrating order information including orders in different shifts;

FIG. 9 is a diagram illustrating work data in which work groups are set based on order shifts;

FIG. 10 is a diagram illustrating order information including different item attributes;

FIG. 11 is a diagram illustrating work data in which work groups are set based on item attributes;

FIG. 12 is a diagram illustrating order information including a picking sequence;

FIG. 13 is a diagram illustrating order information sorted based on a picking sequence;

FIG. 14 is a diagram illustrating work data generated based on a picking sequence; and

FIG. 15 is a flowchart illustrating a method for processing an item order.

### DETAILED DESCRIPTION

Hereinafter, example details for the practice of the present disclosure will be described in detail with reference to the accompanying drawings. However, in the following description, detailed descriptions of well-known functions or configurations will be omitted if it may make the subject matter of the present disclosure rather unclear.

In the accompanying drawings, the same or corresponding components are assigned the same reference numerals. In addition, in the following description of various examples, duplicate descriptions of the same or corresponding components may be omitted. However, even if descriptions of components are omitted, it is not intended that such components are not included in any example.

Advantages and features of the disclosed examples and methods of accomplishing the same will be apparent by referring to examples described below in connection with the accompanying drawings. However, the present disclosure is not limited to the examples disclosed below, and may be implemented in various forms different from each other, and the examples are merely provided to make the present disclosure complete, and to fully disclose the scope of the disclosure to those skilled in the art to which the present disclosure pertains.

The terms used herein will be briefly described prior to describing the disclosed example(s) in detail. The terms used herein have been selected as general terms which are widely used at present in consideration of the functions of the present disclosure, and this may be altered according to the intent of an operator skilled in the art, related practice, or introduction of new technology. In addition, in specific cases, certain terms may be arbitrarily selected by the applicant, and the meaning of the terms will be described in detail in a corresponding description of the example(s). Therefore, the terms used in the present disclosure should be defined based on the meaning of the terms and the overall content of the present disclosure rather than a simple name of each of the terms.

As used herein, the singular forms “a,” “an,” and “the” are intended to include the plural forms as well, unless the context clearly indicates the singular forms. Further, the plural forms are intended to include the singular forms as well, unless the context clearly indicates the plural forms. Further, throughout the description, when a portion is stated as “comprising (including)” a component, it is intended as meaning that the portion may additionally comprise (or include or have) another component, rather than excluding the same, unless specified to the contrary.

Further, the term “module” or “unit” used herein refers to a software or hardware component, and “module” or “unit” performs certain roles. However, the meaning of the “module” or “unit” is not limited to software or hardware. The “module” or “unit” may be configured to be in an addressable storage medium or configured to play one or more processors. Accordingly, as an example, the “module” or “unit” may include components such as software components, object-oriented software components, class components, and task components, and at least one of processes, functions, attributes, procedures, subroutines, program code segments, drivers, firmware, micro-codes, circuits, data, database, data structures, tables, arrays, and variables. Furthermore, functions provided in the components and the “modules” or “units” may be combined into a smaller number of components and “modules” or “units,” or further divided into additional components and “modules” or “units.”

The “module” or “unit” may be implemented as a processor and a memory. The “processor” should be interpreted broadly to encompass a general-purpose processor, a central processing unit (CPU), a microprocessor, a digital signal processor (DSP), a controller, a microcontroller, a state machine, and so forth. Under some circumstances, the “processor” may refer to an application-specific integrated circuit (ASIC), a programmable logic device (PLD), a field-programmable gate array (FPGA), and so on. The “processor” may refer to a combination for processing devices, e.g., a combination of a DSP and a microprocessor, a combination of a plurality of microprocessors, a combination of one or more microprocessors in conjunction with a DSP core, or any other combination of such configurations. In addition, the “memory” should be interpreted broadly to encompass any electronic component that is capable of storing electronic information. The “memory” may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, and so on. The memory is said to be in electronic communication with a processor if the processor can read information from and/or write information to the memory. The memory integrated with the processor is in electronic communication with the processor.

In the present disclosure, a “system” may refer to at least one of a server device and a cloud device, but not limited thereto. For example, the system may include one or more server devices. In another example, the system may include one or more cloud devices. In still another example, the system may include both the server device and the cloud device operated in conjunction with each other.

In addition, terms such as first, second, A, B, (a), (b), etc. used in the following examples are only used to distinguish certain components from other components, and the nature, sequence, order, etc. of the components are not limited by the terms.

In addition, in the following examples, if a certain component is stated as being “connected,” “combined” or “coupled” to another component, it is to be understood that there may be yet another intervening component “connected,” “combined” or “coupled” between the two components, although the two components may also be directly connected or coupled to each other.

In addition, as used in the following examples, “comprise” and/or “comprising” does not foreclose the presence or addition of one or more other elements, steps, operations, and/or devices in addition to the recited elements, steps, operations, or devices.

Before describing various examples of the present disclosure, terms used will be described.

A “work station” may be understood as a place where the work is performed subsequent to the work processed by the unmanned transfer robot. For example, the work station may be a place related to packaging, intermediate inspection, etc. of the items picked by humans or robots. The subsequent work method may be performed in different manners for each work station. For example, a first work station may be provided for the subsequent work of packaging items such as clothes using a plastic bag, a second work station may be provided for the subsequent work of packaging items requiring careful handling such as bowls and bottles using cushioning materials and paper boxes, and a third work station may be provided for the subsequent work of packaging items such as frozen food using an insulated bag. In addition, attributes may be set for each work station. In this case, the attribute may relate to characteristics of a work to be performed on the work station. For example, a first attribute may relate to the item packaging work using the plastic bag, a second attribute may relate to the packaging work using the cushioning material and the paper box, and a third attribute may relate to the packaging work using the insulated bag.

As another example, the first work may be provided for performing subsequent work on items to be delivered to the first region, the second work may be provided for performing subsequent work on items to be delivered to the second region, and the third work may be provided for performing subsequent work on items to be delivered to the third region. In this case, the first attribute may be associated with the first region, the second attribute may be associated with the second region, and the third attribute may be associated with the third region. As another example, the first work may be provided for performing subsequent work on items related to a first ordering party, the second work may be provided for performing subsequent work on items related to a second ordering party, and the third work may be provided for performing subsequent work on items related to a third ordering party. In this case, the first attribute may relate to the first ordering party, the second attribute may relate to the second ordering party, and the third attribute may relate to the third ordering party. Definitions of the above attributes may be set by a person in charge of managing a warehouse.

As used herein, “work” may refer to a moving work to be performed by an unmanned transfer robot. The work may correspond to visit points of the robot (e.g., the location of the item) in a one-to-one basis. That is, the number of works may be determined so as to correspond to the number of visit points of the robot.

As used herein, “work group” may refer to data formed by including at least one work.

A “group field” may be provided for setting attributes in the work group, and the group field may include at least one work attribute. In this case, the work attribute included in the group field may relate to attributes assigned to the work station. For example, a work attribute list may use a work station attribute list as is. As another example, the work attribute may refer to an attribute derived from the work station attribute, and the work attribute may be compatible with the work station attribute.

When it is described that the attributes are related to each other, it may mean that the attributes match or are compatible with each other. The compatible attributes may be set in advance. For example, attribute Attr_1 may be compatible with each of attributes Attr_1-1, Attr_1-2, and Attr1-3.

Hereinafter, various examples of the present disclosure will be described in detail with reference to the accompanying drawings.

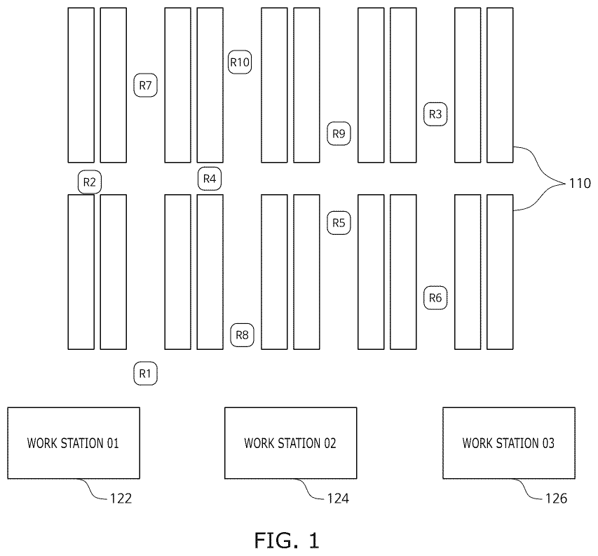

FIG. 1 is a diagram illustrating an example of a distribution system applying a method and system for processing an item order. As illustrated in FIG. 1, the distribution system may include a plurality of work stations 122, 124, and 126, a plurality of shelves 110 for storing items, and a plurality of robots R1 to R10.

The plurality of shelves 110 may store at least one item and may include a plurality of layers. Each of the shelves 110 may be located in a partitioned area and may have unique location information.

The robots R1 to R10 are movable bodies capable of autonomous driving, and may pick items stored on the shelf 110 and transfer the picked items to a work station. The robot R1 to R10 may include a loading unit capable of loading items and a traveling unit, and may autonomously move to a designated destination while having the items loaded on the loading unit. The robot R1 to R10 may cooperate with a worker to load the items to the loading unit. For example, the robot R1 to R10 may move to a location at which items to be picked are located and stand by at the location, and the worker may load the item to be picked into the loading unit of the robot R1 to R10. When completely loaded with the items, the robot R1 to R10 may move to the next destination. Additionally or alternatively, the robot R1 to R10 may include a picking means (e.g., an arm) for picking items, and may use the picking means to load the items into a loading box by itself, that is, without the help of the worker.

Examples of the robot R1 to R10 may include an automated guided vehicle (AGV), an autonomous mobile robot (AMR), a service robot, etc. for the purpose of logistics. The robot R1 to R10 may determine a movement path and at least one item to be picked, based on work data received from an information processing system to be described below.

The work stations 122, 124, and 126 are places provided for the subsequent works on the items, and there may be items (e.g., packaging items, inspection tools, etc.) for the subsequent work piled up around. Workers located at the work stations 122, 124, and 126 may perform the subsequent works on the items transferred by the robots R1 to R10. Once the subsequent works are completed, the items may be post-processed and delivered to designated destinations. For example, if the work stations 122, 124, and 126 are work stations provided for packaging, the packaged items may be loaded into a delivery vehicle and delivered to a delivery destination. Meanwhile, attributes may be assigned to each of the work stations 122, 124, and 126.

In addition, a work group may be set based on the attributes of the items, as will be described below. Accordingly, items having the same or compatible attributes may be transferred to the designated work stations 122, 124, and 126 by the robots R1 to R10. Accordingly, the workers located at the work stations 122, 124, and 126 can efficiently perform the subsequent works on the items. For example, the workers can efficiently perform the subsequent works on the items using the same type of packaging item or inspection tool without having to replace the packaging item, inspection tool, etc.

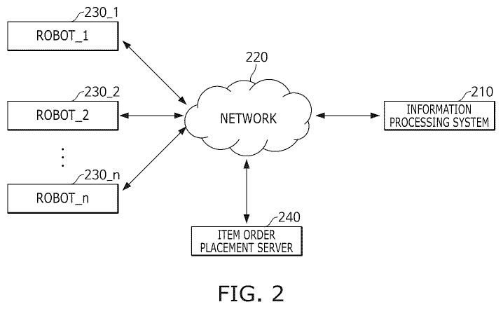

FIG. 2 is a schematic diagram illustrating a configuration in which an information processing system 210 is communicatively connected to a plurality of robots 230_1 to 230_n and an item order placement server 240. As illustrated, the plurality of robots 230_1 to 230_n may communicate with the information processing system 210 through a network 220. The plurality of robots 230_1 to 230_n may receive work data from the information processing system 210, pick items based on the work data and transfer the picked items to the work stations. In addition, the plurality of robots 230_1 to 230_n may receive control commands from the information processing system 210, and controlled to operate based on the control command.

The item order placement server 240 may generate order information including at least one order based on the item order received from a user terminal (not illustrated). Each order (that is, order data) may include identification information, quantity, delivery destination, etc. of the item. The item order placement server 240 may include an on-line shopping mall server, a logistics management server, etc. The item order placement server 240 may transmit item information to the information processing system 210.

The network 220 may be configured to enable communication between the plurality of robots 230_1 to 230_n, the information processing system 210, and the item order placement server 240. The network 220 may be configured as a wired network such as Ethernet, a wired home network (Power Line Communication), a telephone line communication device and RS-serial communication, a wireless network such as a mobile communication network, a wireless LAN (WLAN), Wi-Fi, Bluetooth, and ZigBee, or a combination thereof, depending on the installation environment. The method of communication is not particularly limited, but may include a communication method using a communication network (e.g., mobile communication network, wired Internet, wireless Internet, broadcasting network, satellite network, etc.) that may be included in the network 220 as well as short-range wireless communication the robots 230_1 to 230_n.

The information processing system 210 may include one or more server devices and/or databases, or one or more distributed computing devices and/or distributed databases based on cloud computing services that can store, provide and execute computer-executable programs (e.g., downloadable applications) and data relating to the item order processing, etc. The information processing system 210 may generate a plurality of works based on the order information received from the item order placement server 240 and set a work group including some or all of the plurality of generated works. In addition, the information processing system 210 may set a group field including work attributes in the work group.

The information processing system 210 may determine at least one of the plurality of robots to be a target robot and transmit work data corresponding to the work group to the target robot. The work data may include information on location (e.g., shelf location information) that stores each item and quantity of the items. Accordingly, the target robot may determine a movement path and items to be picked based on the work data, and may pick the items to be picked while moving along the corresponding movement path. Upon completely picking all items, the target robot may move to the designated work station.

According to another example, attributes of the robots 230_1 to 230_n may be assigned. In this case, the robots 230_1 to 230_n may transfer the picked items to the work stations having attributes relating to their own attributes. In addition, the information processing system 210 may identify a plurality of robots having attributes related to the work attributes included in the group field, and determine a target robot from among the identified plurality of robots. That is, according to the attributes of the robots 230_1 to 230_n, the robots 230_1 to 230_n may belong to specific work stations. The attributes of the robots 230_1 to 230_n and attributes of the work station may be determined by a manager. Hereinbelow, it will be described that the robots 230_1 to 230_n are not assigned the attributes.

Meanwhile, although it is illustrated in FIG. 2 that the item order placement server 240 and the information processing system 210 are separated from each other, the item order placement server 240 may be included in the information processing system 210.

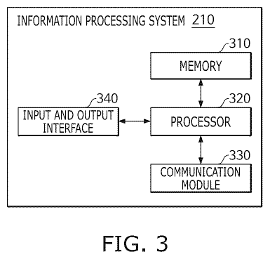

FIG. 3 is a block diagram illustrating an internal configuration of the information processing system 210.

The information processing system 210 may include a memory 310, a processor 320, a communication module 330, and an input and output interface 340. As illustrated in FIG. 3, the information processing system 210 may be configured to communicate information and/or data through a network by using the communication module 330.

The memory 310 may include any non-transitory computer-readable recording medium. The memory 310 may include a permanent mass storage device such as read only memory (ROM), disk drive, solid state drive (SSD), flash memory, and so on. In another example, a non-destructive mass storage device such as ROM, SSD, flash memory, disk drive, and so on may be included in the information processing system 210 as a separate permanent storage device that is distinct from the memory. In addition, the memory 310 may store an operating system and at least one program code (e.g., a code for processing item order, which is installed and driven in the information processing system 210). Although it is illustrated in FIG. 3 that the memory 310 is a single memory, this is only for convenience of description, and the memory 310 may include a plurality of memories.

Software components may be loaded from a computer-readable recording medium separate from the memory 310. Such a separate computer-readable recording medium may include a recording medium directly connectable to the information processing system 210, and may include a computer-readable recording medium such as a floppy drive, a disk, a tape, a DVD/CD-ROM drive, a memory card, etc., for example. In another example, the software components may be loaded into the memory 310 through the communication module 330 rather than the computer-readable recording medium. For example, at least one program may be loaded into the memory 310 based on a computer program (e.g., a program for processing item orders, etc.) installed by the files provided by the developers, or by a file distribution system that distributes an installation file of an application through the communication module 330.

The communication module 330 may provide a configuration or function for the user terminal and/or an external device and the information processing system 210 to communicate with each other through a network, and may provide a configuration or function for the information processing system 210 to communicate with an external system (e.g., item order placement server, etc.).

In addition, the input and output interface 340 of the information processing system 210 may be a means for interfacing with a device (not illustrated) for inputting or outputting, which may be connected to the information processing system 210 or included in the information processing system 210. For example, the input and output interface 340 may include at least one of a PCI express interface and an Ethernet interface. In FIG. 3, the input and output interface 340 is illustrated as a component configured separately from the processor 320, but aspects are not limited thereto, and the input and output interface 340 may be configured to be included in the processor 320. The information processing system 210 may include more components than those illustrated in FIG. 3.

The processor 320 may be configured to process the commands of the computer program by performing basic arithmetic, logic, and input and output computations. The commands may be provided to the processor 320 from the memory 310 or the communication module 330. For example, the processor 320 may be configured to execute the received commands according to a program code stored in a recording device such as the memory 310. The memory 310 stores one or more programs including instructions for acquiring order information including a plurality of item orders, generating a plurality of works based on the order information, setting a work group including some or all of the plurality of generated works, and setting a group field including a work attribute in the work group, and the processor 320 may be configured to execute at least one program.

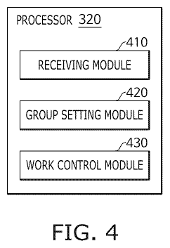

FIG. 4 is a block diagram illustrating an internal configuration of the processor 320 included in the information processing system. As illustrated in FIG. 4, the processor 320 may include a receiving module 410, a group setting module 420 and a work control module 430.

The receiving module 410 may receive data from the other systems and/or devices. For example, the receiving module 410 may receive the order information from the item order placement server through the network. As another example, the receiving module 410 may receive data from the robots.

The group setting module 420 may generate a plurality of works based on the order information including a plurality of item orders, and set a work group including some or all of the generated plurality of works. At this time, the group setting module 420 may include some or all of the plurality of works in the previously generated work group, or may generate a work group including some or all of the plurality of works. In addition, the group setting module 420 may set a group field including work attributes in the work group. The group setting module 420 may identify attributes of each item included in the order information, and set some or all of the plurality of works in the work group based on the identified item attributes. For example, the group setting module 420 may extract orders (that is, order data) having similar or compatible item attributes from the order information, and set works related to the extracted orders in the same work group. In addition, the group setting module 420 may identify a group field related to the attributes of items included in the work group, and set the identified group field in the work group. Accordingly, the attributes of the work group and the work attributes of the group field may be correlated with each other.

Additionally or alternatively, the group setting module 420 may generate a plurality of work groups in advance and assign some or all of the plurality of works in the previously generated work groups based on the attributes of each item included in the order information. Initially, the previously generated work group may not include works, but at least one work may be included in the work group as the order information is acquired. For example, if a first work group having a first attribute and a second work group having a second attribute are generated in advance and then a first work related to the first attribute and a second work related to the second attribute are generated based on the order information, the group setting module 420 may set such that the first work is included in the first work group, and set such that the second work is included in the second work group. Setting the group herein may involve including a work in the previously generated work group or generating a new work group.

In addition, the group setting module 420 may identify an order shift of each item from the order information, and set a work group based on the order shift so as to group at least one work group related to the same order shift.

In addition, the group setting module 420 may set the work group according to various methods. For example, the group setting module 420 may set an order-based work group such that works for items ordered from the same buyer are collected. As another example, the group setting module 420 may set a work group based on the total amount such that the movement line of the robot may be shortened. As still another example, the group setting module 420 may set a work group such that works related to items with similar delivery destination are collected. For example, works related to items having the same administrative district as the delivery destination may be set in the work group.

One method, or a combination methods may be selected from among the group setting methods described above or to be described below. For example, an order-based work group setting method, a total amount-based work group setting method, or a combination method combining these two methods may be selected and applied by the manager (e.g., manager of the distribution system).

The work control module 430 may generate work data related to the work group, transmit the generated work data to the target robot, and control the operation of the robot. The work control module 430 may acquire a work quota and a current location of a plurality of robots, and determine a target robot from among the plurality of robots based on the acquired work quota and location. For example, the work control module 430 may determine, from among the robots located within a predetermined threshold distance from a work station related to the attribute of the work group, a robot having a work quota (e.g., the number of items to be picked) less than or equal to a threshold value to be a target robot. To this end, each robot may report the work progress to the information processing system periodically or in real time, and accordingly, the receiving module 410 may receive the work progress from each robot. In addition, the work control module 430 may identify the work quota of each robot based on the work progress received from each robot, and may also measure the load of each work station.

Meanwhile, the work station may include a buffer for storing work data to be processed. In this case, the information processing system may access the buffer of each work station, acquire capacity of the data stored in each buffer or available capacity of the buffer periodically or in real time, and measure the amount of work of each work station based on the acquired state of the buffer.

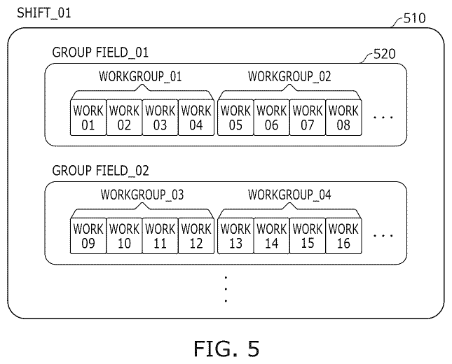

FIG. 5 is a diagram illustrating a work group assigned a group field 520. As illustrated in FIG. 5, each work group (WorkGroup) may include a plurality of works. Although it is illustrated in FIG. 5 that four works are included in each work group, a different number of works may be included in the work group. In addition, the group field 520 may be set for each work group. In FIG. 5, it is illustrated that a Group_Field_01 (520) is set for a WorkGroup_01 and a WorkGroup_02, and a Group_Field_02 is set for a WorkGroup_03 and a WorkGroup_04.

In addition, an order shift (Shift_01) 510 may be set for each work group. It is illustrated in FIG. 5 that the same order shift (that is, Shift_01) is set for WorkGroup_01 to WorkGroup_04. In this case, the order shift may relate to a delivery shift, and for example, a first order shift may relate to a first delivery shift, and a second order shift may relate to a second delivery shift.

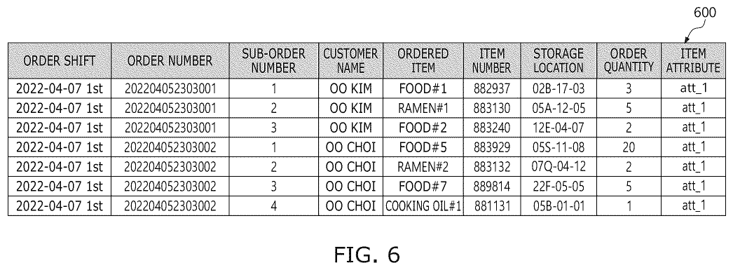

FIG. 6 is a diagram illustrating order information 600 including different buyers. As illustrated in FIG. 6, the order information may include order shift, order number, sub-order number, customer name (that is, buyer name), ordered item, item number, storage location, order quantity, and item attributes. Additionally, the order information may include a delivery destination, a payment amount, a discount amount, etc.

The order shift included in the order information 600 may be information related to the delivery shift. In addition, the order number may be identification information assigned to an item order placed by the buyer, and the sub-order number may be identification information assigned to each of the items in that order. That is, the sub-order number may be sub-information of the order number. In this case, the order numbers may not overlap with each other, and the sub-order numbers may not overlap with each other in the corresponding order number. The order number may be assigned to a list of items ordered by a specific user, and the sub-order number may be assigned to each of the items included in the item list. FIG. 6 illustrates that an order number “202204052303001” is assigned to the order generated by “OO Kim” on 2022 Apr. 7, and sub-order numbers (e.g., 1 to 3) are assigned to each of the items ordered by “OO Kim”. The ordered items may relate to item name, and the item number may be the identification information of the corresponding item managed by the information processing system.

The storage location is data related to a location where the corresponding product is to be stored, and may be a shelf location, for example. In addition, the order quantity may be the quantity of the ordered items, and the item attribute may refer to an attribute of the corresponding item.

A management table including the item numbers, the storage locations, and the item attributes mapped with each other may be stored in at least one of the information processing system and the item order placement server. If the management table is stored in the information processing system only, the item number, the storage location, and the item attributes may be identified by the information processing system. In this case, the item number, the storage location, and the item attribute in the table of FIG. 6 may be filled in by the information processing system.

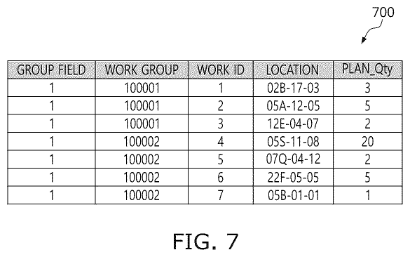

FIG. 7 is a diagram illustrating work data 700 in which work groups are set based on buyers. As illustrated in FIG. 7, the work data 700 may include a group field, a work group, a work ID, a location, and a quantity (Plan_Qty). For example, a work having a unique ID may be generated from the order information illustrated in FIG. 6, and a work group including at least one work may be set as illustrated in FIG. 7. Generating the work data may be performed by at least one processor included in the information processing system.

FIG. 7 illustrates that two work groups having identification information “100001” and “100002” are set. That is, FIG. 7 illustrates that work groups as many as the customers (that is, buyers) are set. In FIG. 7, the work group having the identification information “100001” may relate to the order of buyer “OO Kim,” and the work group having identification information “100002” may relate to the order of buyer “OO Choi”.

In addition, each work can be generated based on storage location. That is, the information processing system may identify the storage location of each of the items included in the order information and generate a work for each storage location. Accordingly, the number of works corresponding to the number of storage locations may be generated. For example, there are 7 different storage locations in the order information of FIG. 6, and accordingly, work data having 7 works as illustrated in FIG. 7 may be generated. A group field may be set for each work group. FIG. 7 illustrates that the group field having identification information “1” is set for “100001” and “100002”.

The work data 700 may be transmitted to at least one robot. If the work data 700 is distributed to two robots, the sub-work data corresponding to the work group “100001” may be transmitted to the first robot, and the sub-work data corresponding to the work group of “100002” may be transmitted to the second robot.

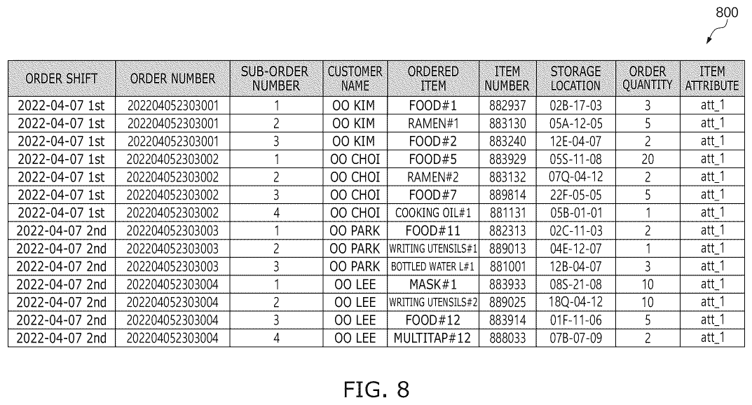

FIG. 8 is a diagram illustrating order information 800 including orders in different shifts. As illustrated in FIG. 8, the orders in different shifts (first shift or second shift) may be included in the order information. In the order information 800 of FIG. 8, it is illustrated that the orders placed by “OO Kim” and “OO Choi” are the first order shifts, and the order data placed by “OO Park” and “OO Lee” are the second order shifts. In this case, the works related to the first order shifts and the works related to the second order shifts may be included in different work groups.

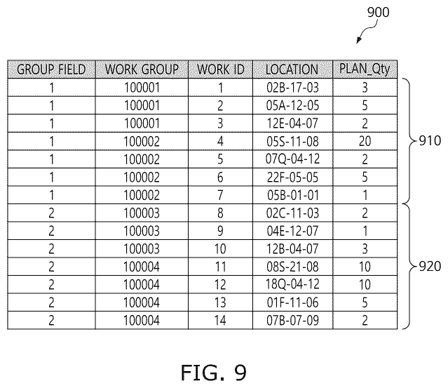

FIG. 9 is a diagram illustrating work data 900 in which work groups are set based on the order shifts. As illustrated in FIG. 9, works related to items corresponding to the first order shift may be included in at least one of work groups having “100001” or “100002” identification information, and works related to items corresponding to the second order shift may be included in at least one of work groups having “100003” or “100004” identification information. In addition, different group fields may be set for the corresponding work group according to the order shift.

Sub-work data 910 and 920 included in the work data 900 may be transmitted to one robot or may be transmitted to two or more robots in a distributed manner. For example, the first sub-work data 910 may be transmitted to a first robot, and the second sub-work data 920 may be transmitted to a second robot.

As another example, the sub-work data included in the work data 900 may be transmitted to the robot(s) with a time difference. For example, the first sub-work data 910 may be transmitted to the first robot, and the second sub-work data 920 may be transmitted to the first robot or the other robots after a predetermined time.

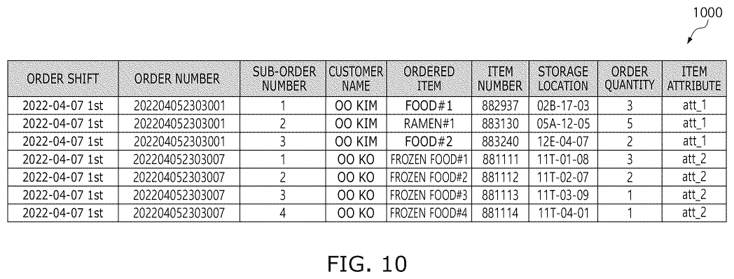

FIG. 10 is a diagram illustrating order information 1000 including different item attributes. As illustrated in FIG. 10, the items ordered by “OO Kim” and the items ordered by “OO Ko” may have different item attributes. In this case, different work groups may be set according to item attributes.

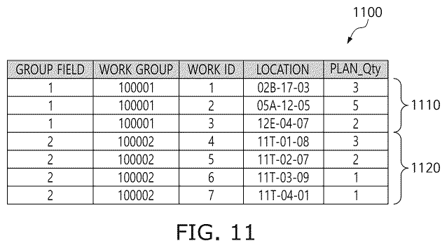

FIG. 11 is a diagram illustrating work data 1100 in which the work groups are set based on the item attributes. The work data 1100 illustrated in FIG. 11 is generated based on the order information of FIG. 10, and as illustrated, works related to items having a first attribute (att_1) may be set in a “100001” work group, and works related to items having a second attribute (att_2) may be set in a “100002” work group. In addition, since the different item attributes are included in each of the work groups, group fields having different attributes may be set in each work group.

Sub-work data 1110 and 1120 included in the work data 1100 may be transmitted to two or more robots in a distributed manner based on the group field. For example, the first sub-work data 1110 may be transmitted to the first robot, and the second sub-work data 1120 may be transmitted to the second robot.

The work group may be set such that the movement path of the robot is the shortest distance.

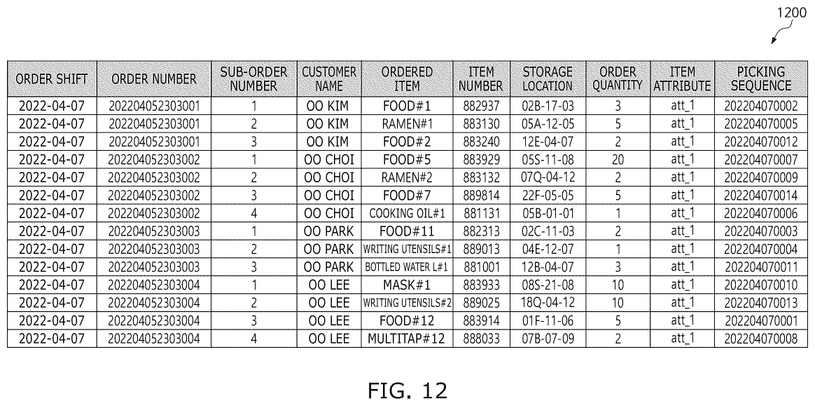

FIG. 12 is a diagram illustrating order information 1200 including a picking sequence. In this example, the picking sequence may be a priority of picking the items of the ordered items. That is, the picking sequence may be a working order. FIG. 12 illustrate that the picking sequence has a format in which an eight-digit date and a four-digit number are combined.

The information processing system may identify a point through which the robot must pass (that is, an item storage location) based on the storage location of each item, and determine a path of the shortest distance by combining the identified item storage locations (passing points). In addition, the information processing system may determine the order of waypoints according to the shortest distance, and determine the picking sequence of items based on the order of waypoints. To this end, the information processing system may store a map of a distribution warehouse where each shelf is located, and may also be equipped with an algorithm for calculating the shortest distance if a plurality of waypoints are set for the distribution warehouse map.

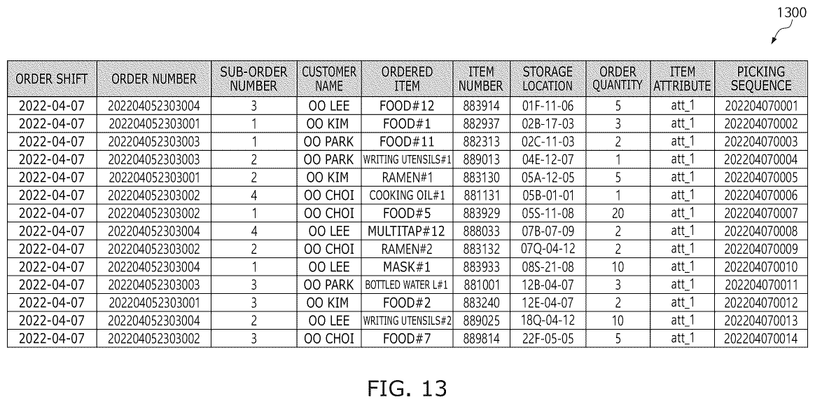

FIG. 13 is a diagram illustrating order information 1300 sorted based on the picking sequence. As illustrated in FIG. 13, the orders included in the order information 1300 may be sorted based on the picking sequence.

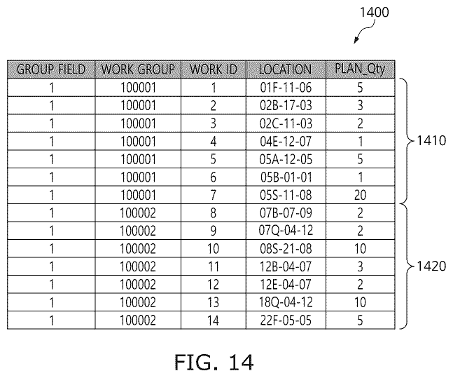

FIG. 14 is a diagram illustrating work data 1400 generated based on the picking sequence. The work data 1400 illustrated in FIG. 14 is generated based on the order information of FIG. 13, and as illustrated, among the orders sorted according to the picking sequence, works related to the first picking sequence to the seventh picking sequence may be set in the “100001” work group, and works related to the eighth picking sequence to the 14th picking sequence may be set in the “100002” work group.

Setting such that the work groups have continuous picking sequences is merely one example, and the groups may be set using various factors as well as the picking sequence. For example, the robot may receive a work set with a higher priority in the middle of processing the works according to the work data. In this case, the working order set for the robot may be changed. As another example, the robot may pick items in collaboration with the worker. In this case, the work group may be set based on the worker's movement line and the worker's load. The work group may be set based on intervening works, higher-priority works, changes in the robot movement path, loads of the collaborating workers, movement lines of collaborating workers, etc.

Some or all of the work data 1400 may be transmitted to at least one robot. For example, the work data 1400 may be divided into two data based on the amount of work, and the divided data, i.e., first sub-work data 1410 may be transmitted to the first robot, and second sub-work data 1420 may be transmitted to the second robot.

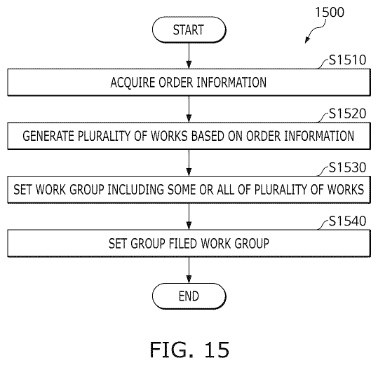

FIG. 15 is a flowchart illustrating a method 1500 for processing an item order. The method illustrated in FIG. 15 is merely one example of achieving the object of the present disclosure, and it goes without saying that some steps may be added or deleted as necessary. In addition, the method illustrated in FIG. 15 may be performed by one or more processors included in the information processing system illustrated in FIG. 2. For convenience of description, it will be described that each step of operation illustrated in FIG. 15 is performed by the processor included in the information processing system illustrated in FIG. 2.

The processor may acquire order information including a plurality of item orders, at S1510. The process may receive the order information including the plurality of item orders from an external device (e.g., item order placement server). Each item order may include order shift, order number, customer name, order item, item number, storage location, order quantity, item attributes, delivery destination, etc.

The processor may generate a plurality of works based on the order information, at S1520. The processor may identify a storage location of each item included in the order information and generate a work for each identified storage location. Accordingly, the number of generated works may correspond to the sum of the number of storage locations of each item included in the order information.

The processor may set a work group including some or all of the plurality of generated works, at S1530. The processor may identify attributes of each item included in the order information, and set some or all of the plurality of works as a work group based on the identified item attributes.

In addition to the attributes, work groups may be set in various ways. For example, the processor may extract at least one work related to the same buyer from among a plurality of works, and set the extracted at least one work in the same work group. As another example, the processor may set at least one work related to a delivery destination within a predetermined distance in a work group, based on the delivery destination of each item included in the order information. As another example, the processor may identify a location at which each work is performed based on the location of each item included in the order information, and set a work group including some or all of the plurality of works based on the identified location of each work. As another example, the processor may determine a processing sequence of each work based on the location of each work, and set a work group based on the determined processing sequence of each work. For example, the processor may set a work group such that works having consecutive processing sequences are included in the same work group. The processor may determine the processing sequence of each work (that is, the sequence of visiting stops) such that the movement path of visiting all of the work locations is the shortest distance.

Meanwhile, the processor may set at least one work group related to the same order shift in the order shift group based on the order shift of the item included in the order information. For example, if the first and second work groups are related to the first order shift and the third and fourth work groups are related to the second order shift, the first and second work groups may be set in the group related to the first order shift, and the third and fourth work groups may be set in the group related to the second order shift. That is, the work groups may be re-grouped with respect to the order shifts.

Upon completing setting the work group, the processor may set a group field including the work attributes for the work group, at S1540. The processor may identify the attribute of the item included in the work group, identify the group field having the work attribute related to the attribute of the item, and set the identified group field for the work group. For example, if the item attribute of the fifth work group is a attribute related to frozen storage and the third group field attribute is a attribute related to freezing work, the third group field may be set for the fifth work group.

Upon completing setting the group field, the processor may determine a target robot from among a plurality of robots and transmit work data related to the work group to the target robot. The processor may determine the target robot from among a plurality of robots. In this case, the processor may determine the target robot based on at least one of the work quota of each of a plurality of robots or the location of each robot.

Meanwhile, if the amount of work assigned to a specific work station is less than a threshold value, the processor may induce transfer of the item to the work station. The processor may send a message to each robot in response to the assigned amount of work at the work station being less than the threshold value, in which the message may include the work station attributes and work station identification information. Upon receiving the message including the attributes of the work station, the robot may compare the attributes of the item being processed with the attributes included in the message, and if determining a relevance, the robot may transfer the picked item to the work station corresponding to the identification information included in the message.

The flowchart and description described above are merely examples, and may be implemented differently in some examples. For example, in some examples, the order of respective steps may be changed, some steps may be repeatedly performed, some steps may be omitted, or some steps may be added.

The method described above may be provided as a computer program stored in a computer-readable recording medium for execution on a computer. The medium may be a type of medium that continuously stores a program executable by a computer, or temporarily stores the program for execution or download. In addition, the medium may be a variety of recording means or storage means having a single piece of hardware or a combination of several pieces of hardware, and is not limited to a medium that is directly connected to any computer system, and accordingly, may be present on a network in a distributed manner. An example of the medium includes a medium configured to store program instructions, including a magnetic medium such as a hard disk, a floppy disk, and a magnetic tape, an optical medium such as a CD-ROM and a DVD, a magnetic-optical medium such as a floptical disk, and a ROM, a RAM, a flash memory, and so on. In addition, other examples of the medium may include an app store that distributes applications, a site that supplies or distributes various software, and a recording medium or a storage medium managed by a server.

The methods, operations, or techniques of the present disclosure may be implemented by various means. For example, these techniques may be implemented in hardware, firmware, software, or a combination thereof. Those skilled in the art will further appreciate that various illustrative logical blocks, modules, circuits, and algorithm steps described in connection with the disclosure herein may be implemented in electronic hardware, computer software, or combinations of both. To clearly illustrate this interchangeability of hardware and software, various illustrative components, blocks, modules, circuits, and steps have been described above generally in terms of their functionality. Whether such a function is implemented as hardware or software varies depending on design requirements imposed on the particular application and the overall system. Those skilled in the art may implement the described functions in varying ways for each particular application, but such implementation should not be interpreted as causing a departure from the scope of the present disclosure.

In a hardware implementation, processing units used to perform the techniques may be implemented in one or more ASICs, DSPs, digital signal processing devices (DSPDs), programmable logic devices (PLDs), field programmable gate arrays (FPGAs), processors, controllers, microcontrollers, microprocessors, electronic devices, other electronic units designed to perform the functions described in the present disclosure, computer, or a combination thereof.

Accordingly, various example logic blocks, modules, and circuits described in connection with the present disclosure may be implemented or performed with general purpose processors, DSPs, ASICs, FPGAs or other programmable logic devices, discrete gate or transistor logic, discrete hardware components, or any combination of those designed to perform the functions described herein. The general purpose processor may be a microprocessor, but in the alternative, the processor may be any related processor, controller, microcontroller, or state machine. The processor may also be implemented as a combination of computing devices, for example, a DSP and microprocessor, a plurality of microprocessors, one or more microprocessors associated with a DSP core, or any other combination of the configurations.

In the implementation using firmware and/or software, the techniques may be implemented with instructions stored on a computer-readable medium, such as random access memory (RAM), read-only memory (ROM), non-volatile random access memory (NVRAM), programmable read-only memory (PROM), erasable programmable read-only memory (EPROM), electrically erasable PROM (EEPROM), flash memory, compact disc (CD), magnetic or optical data storage devices, etc. The instructions may be executable by one or more processors, and may cause the processor(s) to perform certain aspects of the functions described in the present disclosure.

If implemented in software, the techniques described above may be stored on a computer-readable medium as one or more instructions or codes, or may be sent via a computer-readable medium. The computer-readable media include both the computer storage media and the communication media including any medium that facilitates the transmission of a computer program from one place to another. The storage media may also be any available media that may be accessed by a computer. By way of non-limiting example, such a computer-readable medium may include RAM, ROM, EEPROM, CD-ROM or other optical disk storage, magnetic disk storage or other magnetic storage devices, or any other media that can be used to transmit or store desired program code in the form of instructions or data structures and can be accessed by a computer. In addition, any connection is properly referred to as a computer-readable medium.

For example, if the software is sent from a website, server, or other remote sources using coaxial cable, fiber optic cable, twisted pair, digital subscriber line (DSL), or wireless technologies such as infrared, wireless, and microwave, the coaxial cable, the fiber optic cable, the twisted pair, the digital subscriber line, or the wireless technologies such as infrared, wireless, and microwave are included within the definition of the medium. The disks and the discs used herein include CDs, laser disks, optical disks, digital versatile discs (DVDs), floppy disks, and Blu-ray disks, where disks usually magnetically reproduce data, while discs optically reproduce data using a laser. The combinations described above should also be included within the scope of the computer-readable media.

The software module may reside in RAM memory, flash memory, ROM memory, EPROM memory, EEPROM memory, registers, hard disk, removable disk, CD-ROM, or any other form of storage medium known. An exemplary storage medium may be connected to the processor, such that the processor may read or write information from or to the storage medium. Alternatively, the storage medium may be integrated into the processor. The processor and the storage medium may exist in the ASIC. The ASIC may exist in the user terminal. Alternatively, the processor and storage medium may exist as separate components in the user terminal.

Although the examples described above have been described as utilizing aspects of the currently disclosed subject matter in one or more standalone computer systems, aspects are not limited thereto, and may be implemented in conjunction with any computing environment, such as a network or distributed computing environment. Furthermore, the aspects of the subject matter in the present disclosure may be implemented in multiple processing chips or devices, and storage may be similarly influenced across a plurality of devices. Such devices may include PCs, network servers, and portable devices.

Although the present disclosure has been described in connection with some examples herein, various modifications and changes can be made without departing from the scope of the present disclosure, which can be understood by those skilled in the art to which the present disclosure pertains. In addition, such modifications and changes should be considered within the scope of the claims appended herein.

1. A method performed by one or more processors, the method comprising:
acquiring order information including a plurality of item orders;
generating, based on the order information, a plurality of works;
setting a work group including at least one of the generated plurality of works;
setting, for the work group, a group field including a work attribute; and
transmitting, to a target robot and based on an amount of work assigned to a work station being less than a threshold value, a message including an attribute of the work station to cause the target robot to determine an action associated with the work station.

2. The method according to claim 1, further comprising:
after the setting the group field,
determining the target robot from among a plurality of robots; and
transmitting, to the target robot, work data related to the work group.

3. The method according to claim 2, wherein the determining the target robot comprises determining the target robot based on at least one of:
a work quota of each of the plurality of robots; or
a location of each of the plurality of robots.

4. The method according to claim 2, wherein the transmitting the message comprises:
after the transmitting the work data to the target robot, transmitting the message, and
wherein the method further comprises causing the target robot to transfer, in response to the message, an item to the work station, and wherein an attribute of the item is related to the attribute of the work station.

5. The method according to claim 1, wherein the setting the work group comprises:
identifying an attribute of each item included in the order information; and
setting, based on the identified attribute, at least one of the plurality of works in the work group,
wherein the setting the group field comprises:
based on a determination that an attribute of an item associated with the work group is related to the work attribute, setting the group field for the work group.

6. The method according to claim 1, wherein the setting the work group comprises setting, in the work group, at least one of the plurality of works related to a same buyer.

7. The method according to claim 1, wherein the setting the work group comprises:
based on a delivery destination of each item, setting, in the work group, at least one work related to the delivery destination within a predetermined distance.

8. The method according to claim 1, further comprising:
based on an order shift of an item, setting at least one work group related to a same order shift as a group for the order shift.

9. The method according to claim 1, wherein the setting the work group comprises:
identifying a location at which a work is to be performed; and
based on the identified location, setting the work group including at least one of the plurality of works.

10. The method according to claim 9, wherein the identifying the location at which the work is performed comprises:
identifying a storage location of an item related to the work; and
identifying the identified storage location as the location at which the work is to be performed.

11. The method according to claim 1, wherein the setting the work group comprises:
determining a processing sequence for each of the plurality of works; and
setting, based on the determined processing sequence of each of the plurality of works, the work group.

12. The method according to claim 1, wherein the generating the plurality of works comprises:
identifying a storage location of each item included in the order information; and
generating a work for each identified storage location.

13. An information processing system comprising:
one or more processors; and
a memory storing instructions that, when executed by the one or more processors, cause the information processing system to:
acquire order information including a plurality of item orders,
generate, based on the order information, a plurality of works;
set a work group including at least one of the generated plurality of works;
set, for the work group, a group field including a work attribute; and
transmit, to a target robot and based on an amount of work assigned to a work station being less than a threshold value, a message including an attribute of the work station to cause the target robot to determine an action associated with the work station.

14. A method performed by one or more processors, the method comprising:
acquiring order information including a plurality of item orders, wherein each of the plurality of item orders includes associated item attributes;
generating, based on the plurality of item orders, a plurality of works;
grouping, based on item attributes, the generated plurality of works into a plurality of work groups, wherein each work group of the plurality of work groups includes works having a same item attribute or compatible item attributes;
assigning a work attribute to each of the plurality of work groups;
allocating the plurality of works to a plurality of robots;
measuring an amount of work to be processed at a specific work station of a plurality of work stations;
based on the measured amount of work being less than a threshold value, transmitting a message including an attribute of the specific work station to the plurality of robots, wherein the attribute of the specific work station indicates information related to characteristics of a subsequent work to be performed at the specific work station, and the attribute of the specific work station has at least one associated work attribute; and
causing a specific robot of the plurality of robots to move, in response to the message, to the specific work station,
wherein the specific robot that moves to the specific work station is a robot assigned a work having a work attribute associated with the attribute of the specific work station.
